(19) United States
(12) Patent Application Publication
(10) Pub. No.: US 2009/0122394 A1
(43) Pub. Date: May 14, 2009

(54) Camera Module

(76) Inventor: Sung Ho Son, Gwangmyeong-si (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/269,348

(22) Filed: Nov. 12, 2008

(30) Foreign Application Priority Data
Nov. 12, 2007 (KR) 10-2007-0114757

(51) Int. Cl. G02B 7/00

(52) U.S. Cl. 359/353

(57) ABSTRACT

A camera module according to an embodiment includes a lens barrel having a lens, a housing having an upper portion coupled with the lens barrel, a printed circuit board coupled to a lower portion of the housing and provided thereon with an image sensor and an infrared LED that emits infrared rays, and an infrared cut-off filter positioned above the lens barrel. The infrared cut-off filter is movable to inhibit the infrared rays from being incident into the lens barrel or to allow the infrared rays to be incident into the lens barrel.

### CROSS-REFERENCE TO RELATED APPLICATION

The present application claims the benefit under 35 U.S.C. §119 of Korean Patent Application No. 10-2007-0114757, filed Nov. 12, 2007, which is hereby incorporated by reference in its entirety.

### BACKGROUND

1. Field of the Invention

The embodiment relates to a camera module.

2. Related Art

A closed-circuit television (CCTV) is installed at a specific place to monitor situation of the specific place from a place remote from the specific place.

To this end, the CCTV includes an image transmitter for transmitting images and a display unit for transmitting the image transmitted from the image transmitter to a display device. The display unit can record the image transmitted from the image transmitter or can output a specific image.

A camera used for the conventional CCTV is divided into a general camera, which is used in a place where illumination is constantly maintained, and an infrared camera having a light emitting diode (hereinafter, referred to as LED), which is used in a place where illumination varies depending on external environment.

If the illumination is lowered below a predetermined level, power is automatically supplied to the infrared camera, thereby operating an infrared LED. Thus, an image having high quality is provided to a user due to light emitted from the infrared LED. The infrared camera is conveniently used under various environments, so that research and development for the infrared camera is actively performed.

However, the conventional infrared camera cannot properly photograph images in day time because sunlight includes infrared rays. Due to the infrared rays, the image photographed by the conventional infrared camera is saturated as compared with an actual image.

In addition, even if an infrared cut-off filter is installed in the infrared camera to filter visible rays and infrared rays having predetermined bands, a color of an image is distorted when a user photographs the image in day time due to the infrared rays contained in the sunlight.

### BRIEF SUMMARY

An embodiment provides a camera module capable of simultaneously using an infrared camera and a general camera.

A camera module according to an embodiment comprises: a lens barrel having a lens; a housing having an upper portion coupled with the lens barrel; a printed circuit board coupled to a lower portion of the housing and provided thereon with an image sensor and an infrared LED that emits infrared rays; and an infrared cut-off filter positioned above the lens barrel, wherein the infrared cut-off filter is movable to inhibit the infrared rays from being incident into the lens barrel or to allow the infrared rays to be incident into the lens barrel.

In addition, a camera module according to an embodiment comprises: a lens barrel having a lens; a housing having an upper portion coupled with the lens barrel; a printed circuit board coupled to a lower portion of the housing and provided thereon with an image sensor and an infrared LED that emits infrared rays; an infrared cut-off filter positioned above the lens barrel; a post for supporting the infrared cut-off filter; a guide for providing a moving route of the post; and a handle extending from one side of the post to move the infrared cut-off filter.

### BRIEF DESCRIPTION OF THE DRAWINGS

FIG. 1 is a cross-sectional view showing a camera module according to an embodiment; and

FIGS. 2 and 3 are views showing an operational state of a camera module according to an embodiment.

### DETAILED DESCRIPTION

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

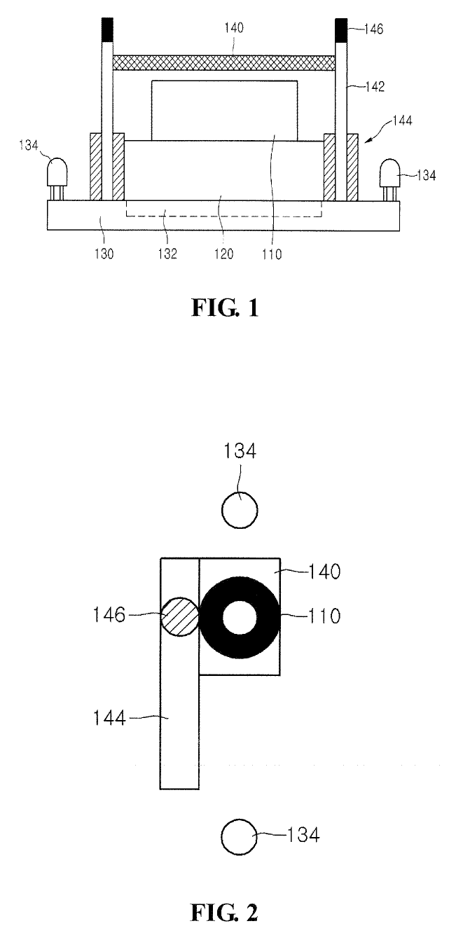

FIG. 1 is a cross-sectional view showing a camera module according to an embodiment

Referring to FIG. 1, the camera module according to the embodiment includes a lens barrel 110, in which a plurality of lenses are installed, a housing 120 inserted into an upper opening section of the lens barrel 110, and a printed circuit board 130 coupled with a lower opening section of the housing 120.

The lens barrel 110 coupled with the upper opening section of the housing 120 serves as a lens holder and is made from resin material, such as polycarbonate.

A plurality of lenses including apertures and condense lenses are installed in the lens barrel 110 inserted into the housing 120.

The aperture defines a passage of light passing through the condense lens and the light passing through the aperture is introduced into a light receiving section of an image sensor device.

The printed circuit board 130 coupled with the lower opening section of the housing 120 is provided thereon with an image sensor 132, which receives the light passing through the lens barrel 110 to process the light, and a plurality of LEDs 134, which selectively emit infrared rays corresponding to variation of illumination.

The image sensor 132 can be attached to one surface of the printed circuit board 130 (that is, a surface facing an interior of the housing) through a chip on Board (COB) packaging scheme using a wire bonding.

The image sensor 132 includes the light receiving section, which receives the light from the condense lens of the lens barrel 110 to convert an optical signal into an electric signal, and a signal processing section, which processes the electric signal of the light receiving section into image data.

The camera module according to the embodiment includes an infrared cut-off filter 140 installed at an upper portion of the lens barrel 110 to block the infrared ray in day time.

The infrared cut-off filter 140 is supported by at least one post 142 and a guide serving as a moving route of the post 142 is provided at one side or both sides of the housing 120.

For instance, the guide 144 provides the moving route for the infrared cut-off filter 140 in such a manner that the infrared cut-off filter 140 can move between an infrared cut-off position located on the housing 120 and an infrared pass position which deviates from the housing 120.

A handle 146 extends from one side of the post 142 to move the infrared cut-off filter 140.

For instance, the handle 146 is prepared in the form of a ring, such as a zoom ring or a focus ring of the camera, and the user can move the infrared cut-off filter 140 by manipulating the ring in a way similar to a macro scheme.

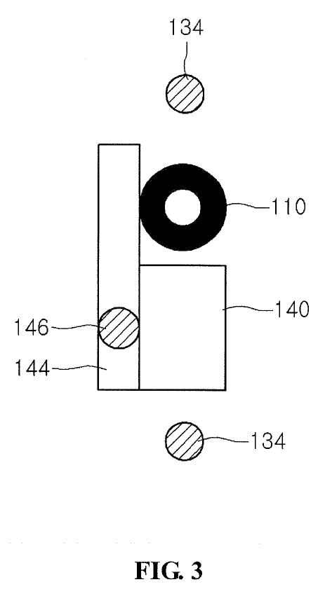

FIGS. 2 and 3 are views showing an operational state of a camera module according to an embodiment.

FIG. 2 shows the operation state of the camera in day time. Referring to FIG. 2, the infrared LED 134 is turned off in day time. In this state, the user manipulates the handle 146 such that the infrared cut-off filter 140 can be positioned above the lens barrel 110, thereby blocking the infrared rays contained in the sunlight.

FIG. 3 shows the operation state of the camera at night. Referring to FIG. 3, the infrared LED 134 is turned on at night. In this state, the user manipulates the handle 146 such that the infrared cut-off filter 140 can be removed from the lens barrel 110, thereby obtaining the image having high quality at night.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A camera module comprising:
a lens barrel having a lens;
a housing having an upper portion coupled with the lens barrel;
a printed circuit board coupled to a lower portion of the housing and provided thereon with an image sensor and an infrared LED that emits infrared rays; and
an infrared cut-off filter positioned above the lens barrel, wherein the infrared cut-off filter is movable to inhibit the infrared rays from being incident into the lens barrel or to allow the infrared rays to be incident into the lens barrel.

2. The camera module as claimed in claim 1, further comprising:
a post for supporting the infrared cut-off filter;
a guide positioned at one side or both sides of the housing to provide a moving route of the post; and
a handle extending from one side of the post to move the infrared cut-off filter.

3. The camera module as claimed in claim 2, wherein the guide provides the moving route for the infrared cut-off filter in such a manner that the infrared cut-off filter moves between an infrared cut-off position where the infrared cut-off filter is installed above the lens barrel and an infrared pass position where the infrared cut-off filter deviates from the housing.

4. The camera module as claimed in claim 2, wherein the handle has a ring shape.

5. The camera module as claimed in claim 1, wherein the infrared LED selectively emits the infrared rays corresponding to variation of illumination.

6. The camera module as claimed in claim 1, wherein the infrared cut-off filter is spaced apart from an upper surface of the lens barrel by a predetermined distance.

7. A camera module comprising:
a lens barrel having a lens;
a housing having an upper portion coupled with the lens barrel;
a printed circuit board coupled to a lower portion of the housing and provided thereon with an image sensor and an infrared LED that emits infrared rays;
an infrared cut-off filter positioned above the lens barrel;
a post for supporting the infrared cut-off filter;
a guide for providing a moving route of the post; and
a handle extending from one side of the post to move the infrared cut-off filter.

8. The camera module as claimed in claim 7, wherein the guide provides the moving route for the infrared cut-off filter in such a manner that the infrared cut-off filter moves between an infrared cut-off position where the infrared cut-off filter is installed above the lens barrel and an infrared pass position where the infrared cut-off filter deviates from the housing.

9. The camera module as claimed in claim 7, wherein the guide is positioned at one side or both sides of the housing.

10. The camera module as claimed in claim 7, wherein the infrared LED selectively emits the infrared rays corresponding to variation of illumination.

11. The camera module as claimed in claim 7, wherein the handle has a ring shape.
